(19) United States
(12) Patent Application Publication
(10) Pub. No.: US 2011/0024101 A1
(43) Pub. Date: Feb. 3, 2011

(54) THERMAL CONDUCTIVE SUBSTRATE AND METHOD OF MANUFACTURING THE SAME

(75) Inventors: Chul Jong Han, Seoul (KR); Won Keun Kim, Gyeonggi-do (KR); Huyn Min Cho, Gyeonggi-do (KR); Soon Hyung Kwon, Seoul (KR)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: KOREA ELECTRONICS TECHNOLOGY INSTITUTE, Gyeonggi-do (KR)

(21) Appl. No.: 12/846,007

(22) Filed: Jul. 29, 2010

(30) Foreign Application Priority Data
Jul. 31, 2009 (KR) 20090070325

(51) Int. Cl. F28F 7/00; B05D 5/12; B21D 53/02

(52) U.S. Cl. 165/185; 427/58; 29/890.03

(57) ABSTRACT

Provided are a thermal conductive substrate having high thermal conductivity, which dissipates heat through as small as possible area thereof, and a method of manufacturing the thermal conductive substrate. The thermal conductive substrate includes a lower heat sink layer, a thermal conductive layer including thermal conductors formed to contact the lower heat sink layer, and an insulating adhesive portion filled between the thermal conductors, and an upper layer formed on the thermal conductor, wherein the upper layer contacts the thermal conductor so as to dissipate heat to the lower heat sink layer.

### BACKGROUND OF THE INVENTION

1. Field of the Invention

The present invention relates to a thermal conductive substrate and a method of manufacturing the same, and more particularly, to a thermal conductive substrate having high thermal conductivity, which dissipates heat through as small as possible area thereof, and a method of manufacturing the thermal conductive substrate.

2. Description of the Related Art

Circuit boards including electronic components such as semiconductor elements mounted thereon have been necessarily used in various fields, for example, home appliance products, vehicles, or electronic controllers of electric equipments. Along with the rapid developments for miniaturization of circuit boards, highly-functionalized and highly-integrated circuit boards are required, and thus the amount of heat that is locally generated in circuits is increased. Since the durability of the circuit board is adversely affected when heat generated from the circuit board accumulates on the circuit board rather than being dissipated away from the circuit board, a circuit board requires high thermal conductivity in addition to electrical reliability such as electrical insulation.

In order to dissipate heat, a heat dissipation plate or metal pin having high thermal conductivity is assembled with and contacts a circuit board so as to transfer and conduct heat. However, if joints of two members contact or short circuit each other, a circuit may be destroyed.

Accordingly, a resin composition layer including an organic polymer composition having high electrical insulation is interposed and insulates between the circuit board and the heat dissipation plate. However, the organic polymer composition for insulation has low thermal conductivity, and a high thermal conductivity of the organic polymer composition cannot be obtained when the organic polymer composition is used alone.

In order to overcome the thermal conductivity issue of the resin composition layer, an inorganic powder having high thermal conductivity is used as a thermal-conductive filler. In addition, an inorganic powder is used as a filler for providing flammability and electrical insulation. For example, an oxide aluminum (Al) powder having high electrical insulation is used as a highly thermal-conductive filer, and a silica powder is used a semiconductor sealing filler due to its high purity.

However, when such an inorganic filler is used, even if the inorganic filler and an organic adhesive component are mixed in any ratio, the inorganic filler is surrounded by the organic adhesive component. Since the organic adhesive component blocks thermal conduction, the organic adhesive component blocks thermal conduction of phonons or electrons that proceed towards inorganic thermal-conductive components. Thus, direct thermal conduction cannot occur between upper and lower portions, thereby reducing thermal conductive efficiency.

Accordingly, there is a need for a heat dissipation plate for effectively dissipating heat of circuit boards.

### SUMMARY OF THE INVENTION

Aspects of the present invention provide a thermal conductive substrate having high thermal conductivity, which dissipates heat through as small as possible area thereof, and a method of manufacturing the thermal conductive substrate.

According to an aspect of the present invention, there is provided a thermal conductive substrate including a lower heat sink layer; a thermal conductive layer including thermal conductors formed to contact the lower heat sink layer, and an insulating adhesive portion filled between the thermal conductors; and an upper layer formed on the thermal conductor, wherein the upper layer contacts the thermal conductor so as to dissipate heat to the lower heat sink layer.

A hardness of the thermal conductor may be equal to or greater than a hardness of the lower heat sink layer and the upper layer. The thermal conductors may be partially intercalated into the lower heat sink layer or the upper layer. Thermal conductors included in the thermal conductive layer may be configured as a single particle layer.

The lower heat sink layer may be an aluminum (Al) substrate, and the upper layer may be a rolled copper foil. The thermal conductors may be diamond particles or boron nitride particles. The insulating adhesive portion may include an epoxy resin. The insulating adhesive portion may further include a rapid hardening agent.

According to an aspect of the present invention, there is provided a method of manufacturing a thermal conductive substrate, the method including forming thermal conductors to be a single layer on a lower heat sink layer so as to contact the lower heat sink layer; filling an adhesive material between the thermal conductors so as to expose upper portions of the thermal conductors; and forming an upper layer so as to contact the exposed upper portion of the thermal conductors.

The method may further include, after the forming of the thermal conductive conductors to be the single layer, pressurizing the thermal conductors from upper surfaces thereof so as to intercalate portions of the thermal conductors into the lower heat sink layer. In addition, the method may further include, after the forming of the upper layer, pressurizing the upper layer from an upper surface thereof so as to intercalate portions of the thermal conductors into the upper layer.

The forming of the thermal conductors may be performed by using an electrostatic-painting method. The filling of the adhesive material may be performed by using a spin coating method.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of a thermal conductive substrate according to an embodiment of the present invention;

FIGS. 2A through 2C are cross-sectional views of thermal conductive substrates including thermal conductors of which locations and shapes are different, according to various embodiments of the present invention; and

FIGS. 3A through 3E are cross-sectional views of a method of manufacturing a thermal conductive substrate, according to an embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

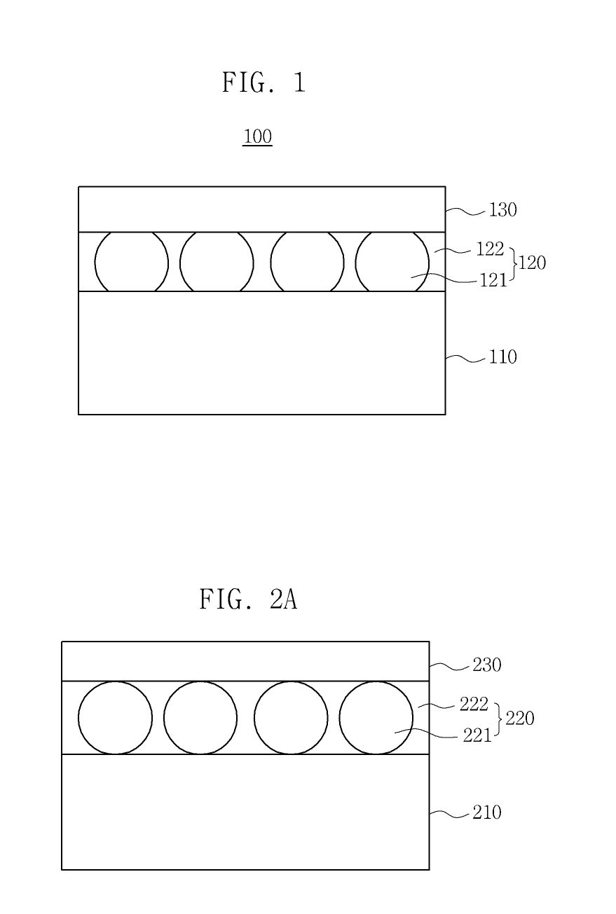

FIG. 1 is a cross-sectional view of a thermal conductive substrate 100 according to an embodiment of the present invention. The thermal conductive substrate 100 includes a lower heat sink layer 110; a thermal conductive layer 120 including thermal conductors 121 formed on the lower heat sink layer 110 so as to contact the lower heat sink layer 110, and an insulating adhesive portion 122 filled in spaces formed between the thermal conductors 121; and an upper layer 130 formed on the thermal conductive layer 120 so as to contact the thermal conductors 121 and to dissipate heat towards the lower heat sink layer 110.

According to the present embodiment, anisotropic thermal conduction technology is used in order to provide direct thermal conduction of a heat transfer material between upper and lower portions. To this end, a contact area with the thermal conductors 121 is maximized in the thermal conductive layer 120 disposed between the lower heat sink layer 110 and the upper layer 130.

The lower heat sink layer 110 is a basic heat dissipation substrate for dissipating heat from the thermal conductive substrate 100, and may be formed of a material having high thermal conductivity. For example, the lower heat sink layer 110 may be formed of metal. Particularly, the lower heat sink layer 110 may include aluminum (Al). This is because Al has high thermal conductivity, and a material cost of Al is not high, and accordingly Al is not disadvantageous for manufacturing costs.

The thermal conductive layer 120 is formed on the lower heat sink layer 110 so as to transmit heat generated from the upper layer 130 to the lower heat sink layer 110. The thermal conductive layer 120 includes the thermal conductors 121 formed to contact the lower heat sink layer 110, and the insulating adhesive portion 122 for providing an adhesion with the upper layer 130 while filling the spaces formed between the thermal conductors 121.

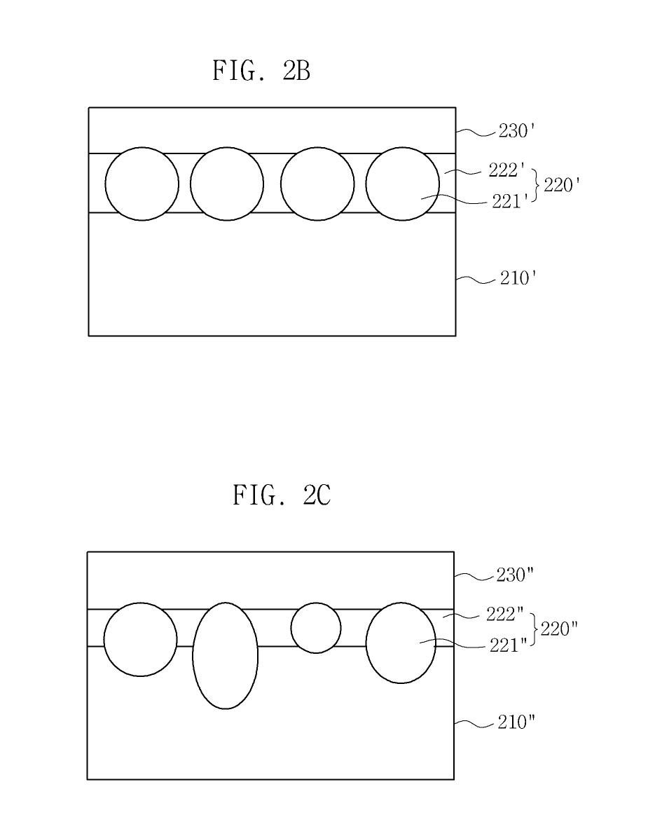

The thermal conductors 121 may transmit the heat generated from the upper layer 130 to the lower heat sink layer 110, and may include a particle having high thermal conductivity. For example, the thermal conductor 121 may include a diamond particle or a boron nitride particle. Since the diamond particle or the boron nitride particle has high thermal conductivity, and has higher hardness than the hardness of the lower heat sink layer 110 and the upper layer 130, the diamond particle or the boron nitride particle is capable of being intercalated into the lower heat sink layer 110 and the upper layer 130, which will be described with reference to FIGS. 2A through 2C.

The thermal conductor 121 included in the thermal conductive layer 120 may be configured as a single particle layer. If the thermal conductor 121 is not a single layer, it may be difficult to expose a predetermined area of upper and lower portions of the thermal conductor 121 in order to achieve thermal conduction, thereby adversely affecting thermal dissipation efficiency.

The insulating adhesive portion 122 may attach the lower heat sink layer 110 and the upper layer 130 to each other while insulating the lower heat sink layer 110 and the upper layer 130 from each other, and may be formed of an adhesive resin. A liquid resin is disposed and hardened between the lower heat sink layer 110 and the upper layer 130, thereby achieving adhesion in addition to insulation. Thus, if the insulating adhesive portion 122 is formed of a resin, the insulating adhesive portion 122 may further include a hardening agent in order to harden the resin.

The upper layer 130 is formed on the thermal conductive layer 120. The upper layer 130 contacts other elements generating heat, such as another circuit board, and transfers the heat to the lower heat sink layer 110 to dissipate the heat. The upper layer 130 may be a rolled copper foil. The upper layer 130 may be patterned so as to mount the external elements thereon.

FIGS. 2A through 2C are cross-sectional views of thermal conductive substrates including thermal conductors 221, 221′ and 221″ of which locations and shapes are different, according to various embodiments of the present invention. In FIGS. 2A through 2C, lower heat sink layers 210, 210′ and 210″, upper layers 230, 230′ and 230″, and insulating adhesive portions 222, 222′ and 222″ are the same as the lower heat sink layer 110, the upper layer 130 and the insulating adhesive portion 122 of FIG. 1, respectively, and thus their detailed descriptions will be omitted.

Referring to FIG. 2A, the thermal conductors 221 are disposed in a thermal conductive layer 220 while upper portions of the thermal conductor 221 contact the upper layer 230, and lower portions of the thermal conductors 221 contact the lower heat sink layer 210. In this case, the thermal conductors 221 transmit heat generated from the upper layer 230 to the lower heat sink layer 210 to facilitate the thermal conduction.

Referring to FIG. 2B, upper portions and lower portions of the thermal conductors 221′ are intercalated into the upper layer 230′ and the lower heat sink layer 210′, respectively. Even in a case of FIG. 2A, thermal conduction may be performed. However, due to a small contact area of the thermal conductor 221 with the upper layer 230 and the lower heat sink layer 210, thermal conduction efficiency needs to be increased. Thus, as illustrated in FIG. 2B, when the thermal conductor 221′ is intercalated into the upper layer 230′ and the lower heat sink layer 210′ so as to increase the contact area, thermal conduction efficiency is increased.

In a case of FIG. 2B, since the thermal conductor 221′ is intercalated into the upper layer 230′ and the lower heat sink layer 210′, an adhesive force between the upper layer 230′ and a thermal conductive layer 220′, and an adhesive force between the thermal conductive layer 220′ and the lower heat sink layer 210′ are increased compared to a case of FIG. 2A.

FIG. 2C illustrates a case where the thermal conductors 221″ have different shapes. Also in FIG. 2C, the thermal conductors 221″ are intercalated into the upper layers 230″ and the lower heat sink layer 210″. Thus, like in the thermal conductive substrate of FIG. 2B, thermal conduction efficiency and adhesion may be improved.

In addition, when the thermal conductors 221′ having the same shape are used like in FIG. 2B, since the upper layer 230′ needs to be adhered onto the thermal conductor 221′, a height difference is small so as to have high manufacturing efficiency compared to in FIG. 2C. However, high manufacturing costs are required in order to form the thermal conductors 221′ having the same shapes like in FIG. 2B, and thus manufacturing costs may be expensive.

Thus, when the thermal conductors 221″ having different shapes are used like in FIG. 2C, if the thermal conductors 221″ is intercalated into the lower heat sink layer 210″ by the same height to contact the upper layers 230″, manufacturing efficiency may be increased. Accordingly, when the thermal conductors 221″ having different shapes are used, manufacturing efficiency may also be increased.

In FIGS. 2B and 2C, the thermal conductors 221′ and 221″ need to be intercalated into the upper layers 230′ and 230″ and the lower heat sink layers 210′ and 210″. Thus, the hardness of the thermal conductors 221′ and 221″ may be higher than the hardness of the upper layers 230′ and 230″ and the lower heat sink layers 210′ and 210″.

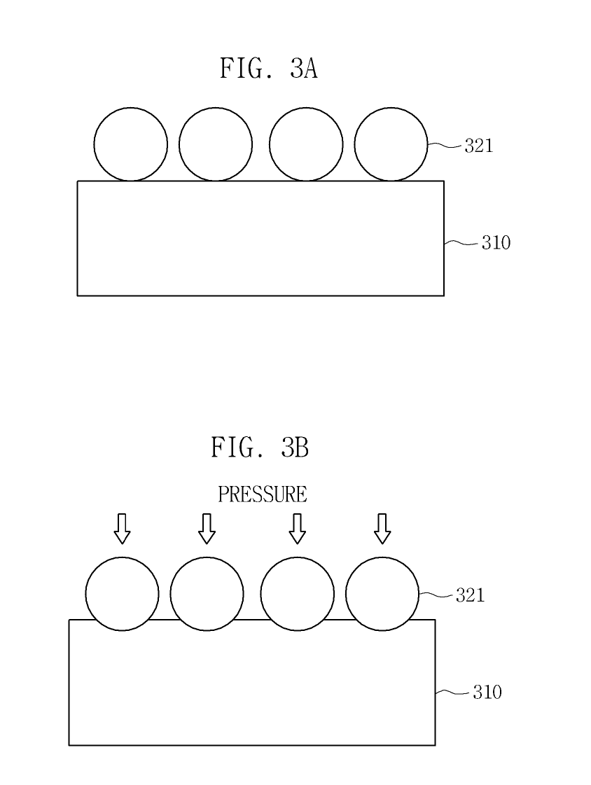

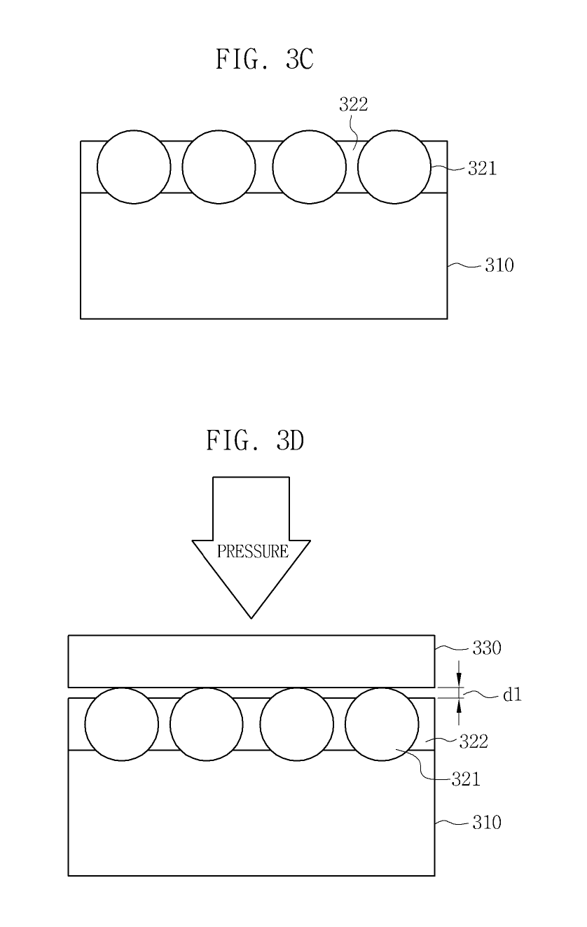

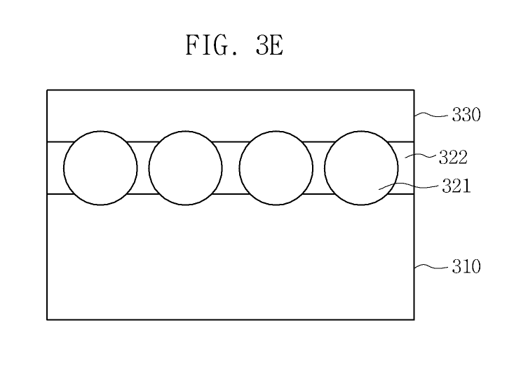

FIGS. 3A through 3E are cross-sectional views of a method of manufacturing a thermal conductive substrate, according to an embodiment of the present invention.

In order to manufacture the thermal conductive substrate, a lower heat sink layer 310 is prepared. Thermal conductors 321 as a single layer are formed on the lower heat sink layer 310 so as to contact the lower heat sink layer 310 (FIG. 3A). As described with reference to FIG. 2C, the thermal conductors 321 may be configured as a single layer. In order to uniformly form the thermal conductors 321 as a single layer, an electrostatic painting technology may be used.

When the electrostatic painting technology is used, the thermal conductors 321 are restricted to a single layer by a repulsion force between the thermal conductors 321 when a high voltage (about 1.5 kV) is applied to the thermal conductors 321 while applying an air pressure to the thermal conductors 321, and a predetermined distance between the particles is maintained.

After the thermal conductor 321 is formed, an adhesive material is filled between the thermal conductors 321 so as to expose an upper portion of the thermal conductor 321 to form an insulating adhesive portion 322 (FIG. 3C). The adhesive material may be filled by using a spin coating method. That is, if the adhesive material is in a liquid state, the adhesive material is poured and is spin-coated onto the lower heat sink layer 310 on which the thermal conductors 321 are formed so as to be filed between the thermal conductors 321.

In this case, when the adhesive material is filled, it is important to expose the upper portion of the thermal conductor 321. If the thickness of the adhesive material is greater than the thickness of the thermal conductors 321, when an upper layer 330 (see FIG. 3D) is formed, the upper layer 330 does not directly contact the thermal conductors 321. In order to overcome this problem, the thickness of the insulating adhesive portion 322 to be filled as the adhesive material may be smaller than the thickness of the thermal conductor 321. Referring to FIG. 3D, a thickness difference between the thermal conductor 321 and the insulating adhesive portion 322 is indicated as ‘d1’. The upper layer 330 is formed on the thermal conductor 321 of which an upper portion is exposed, thereby completing the manufacture of thermal conductive substrate (FIG. 3E).

In the manufacturing the thermal conductive substrate according to the present embodiment, after the forming of the thermal conductors 321 to be a single layer, prior to the forming of the insulating adhesive portion 322, the thermal conductors 321 are pressurized from upper surfaces thereof so as to intercalate portions of the thermal conductors 321 into the lower heat sink layer 310, as shown in FIG. 3B. Thus, an adhesion area between the thermal conductors 321 and the lower heat sink layer 310 may be increased, and upper surfaces of the thermal conductors 321 may be planarized.

As described above, when the upper surfaces of the thermal conductors 321 are planarized, a height difference is reduced when the upper layer 330 is adhered to the thermal conductors 321, thereby increasing manufacturing efficiency. In this case, the hardness of the thermal conductor 321 is higher than that of the lower heat sink layer 310, and thus an appropriate pressure is applied to the thermal conductors 321 downwards so that portions of the thermal conductors 321 may be intercalated into the lower heat sink layer 310, thereby planarizing the upper surfaces of the thermal conductors 321.

When the thermal conductors 321 are intercalated into the lower heat sink layer 310, the thermal conductors 321 are formed as a single uniform layer by coating an adhesive material onto the thermal conductor 321 to form the insulating adhesive portion 322, and thus the thermal conductors 321 are fixed rather than being moved. Accordingly, the thermal conductors 321 are formed to be a single layer at regular intervals so as to contact the lower heat sink layer 310 and the upper layer 330, thereby effectively dissipating heat.

Similarly, after the insulating adhesive portion 322 is formed between the thermal conductors 321, and the upper layer 330 is formed, the upper layer 330 is pressurized from an upper surface thereof so as to intercalate portions of the thermal conductors 321 into the upper layer 330, as shown in FIG. 3D. Thus, when the upper layer 330 is adhered to the thermal conductors 321, the upper layer 330 is pressured so as to cover the exposed portions of the thermal conductors 321, and thus the upper layer 330 and the insulating adhesive portion 322 contact each other. When the upper layer 330 is adhered to the thermal conductors 321, the upper layer 330 needs to be pressured to cover the exposed portions of the thermal conductors 321 so that the upper layer 330 may contact the insulating adhesive portion 322. Thus, the adhesion of the insulating adhesive portion 322 may be obtained. In addition, the thermal conductors 321 may be intercalated into the upper layer 330 so as to increase thermal conductivity.

In Examples 1 and 2, thermal conductive substrates were manufactured by using methods of manufacturing a thermal conductive substrate, according to embodiments of the present invention.

### Example 1

An aluminum (Al) substrate having a thickness of was 1.0 mm prepared as a lower heat sine layer, and then electrostatic-painting was performed on a diamond particle (available from ILJIN DIAMOND, IMPM (8 to 12 mesh)) having a center value of 20 μm to form a diamond particle single layer as a thermal conductor. Then, the diamond particle was intercalated into the Al substrate by pressuring the diamond particle single layer at a pressure of 5 MPa by using a plate press, and an upper surface of the diamond particle single layer was planarized. An epoxy resin (YD-128M, and available from KUKDO Chemical. Co., Ltd.) as an insulating adhesive agent and a rapid hardening agent (HX3932HP, and available from ASHAHI Chemical) were mixed in an equivalent ratio, and were spin-coated at 2000 rpm to have a thickness of 17 μm on the resulting structure. Then, a rolled copper foil having a thickness of 25 μm was formed as an upper layer, and was pressured for 5 minutes at 3 MPa, and 150° C. by using a hot press, thereby completing the manufacture of the thermal conductive substrate.

### Example 2

An Al substrate having a thickness of was 1.0 mm prepared as a lower heat sine layer, and then electrostatic-painting was performed on a boron nitride particle (available from ILJIN DIAMOND, IMPM (8 to 12 mesh)) having a center value of 20 μm to form a boron nitride single layer. Then, the boron nitride particle was intercalated into the Al substrate by pressuring the boron nitride single layer at a pressure of 5 MPa by using a plate press, and an upper surface of the boron nitride single layer was planarized. An epoxy resin (YD-128M, and available from KUKDO Chemical. Co., Ltd.) as an insulating adhesive agent and a rapid hardening agent (HX3932HP, and available from ASHAHI Chemical) were mixed in an equivalent ratio, and were spin-coated at 2000 rpm to have a thickness of 17 μm on the resulting structure. Then, a rolled copper foil having a thickness of 25 μm was formed as an upper layer, and was pressured for 5 minutes at 3 MPa, and 150° C. by using a hot press, thereby completing the manufacture of the thermal conductive substrate.

According to one or more embodiments of the present invention, a lower heat sink layer for heat dissipation and an upper layer may directly contact each other through a thermal conductor, thereby forming a direct thermal conductive path. In a thermal conductive substrate according to one or more embodiments of the present invention, the direct thermal conductive path is formed, and a contact area is increased since the thermal conductor is intercalated into the lower heat sink layer and the upper layer. Accordingly, the thermal conductive substrate according to one or more embodiments of the present invention has higher thermal conductivity than that of a typical thermal conductive substrate, and thus the thermal conductive substrate according to one or more embodiments of the present invention may dissipate heat through as small as possible area thereof, thereby effectively dissipating heat.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A thermal conductive substrate comprising:
a lower heat sink layer;
a thermal conductive layer comprising thermal conductors formed to contact the lower heat sink layer, and an insulating adhesive portion filled between the thermal conductors; and
an upper layer formed on the thermal conductor, wherein the upper layer contacts the thermal conductor so as to dissipate heat to the lower heat sink layer.

2. The thermal conductive substrate of claim 1, wherein a hardness of the thermal conductor is equal to or greater than a hardness of the lower heat sink layer and the upper layer.

3. The thermal conductive substrate of claim 1, wherein the thermal conductors are partially intercalated into the lower heat sink layer or the upper layer.

4. The thermal conductive substrate of claim 1, wherein the thermal conductors included in the thermal conductive layer are configured as a single particle layer.

5. The thermal conductive substrate of claim 1, wherein the lower heat sink layer is an aluminum (Al) substrate, and
wherein the upper layer is a rolled copper foil.

6. The thermal conductive substrate of claim 1, wherein the thermal conductors are diamond particles or boron nitride particles.

7. The thermal conductive substrate of claim 1, wherein the insulating adhesive portion comprises an epoxy resin.

8. The thermal conductive substrate of claim 7, wherein the insulating adhesive portion further comprises a rapid hardening agent.

9. A method of manufacturing a thermal conductive substrate, the method comprising:
forming thermal conductors to be a single layer on a lower heat sink layer so as to contact the lower heat sink layer;
filling an adhesive material between the thermal conductors so as to expose upper portions of the thermal conductors; and
forming an upper layer so as to contact the exposed upper portion of the thermal conductors.

10. The method of claim 9, further comprising: after the forming of the thermal conductive conductors to be the single layer, pressurizing the thermal conductors from upper surfaces thereof so as to intercalate portions of the thermal conductors into the lower heat sink layer.

11. The method of claim 9, further comprising: after the forming of the upper layer, pressurizing the upper layer from an upper surface thereof so as to intercalate portions of the thermal conductors into the upper layer.

12. The method of claim 9, wherein the forming of the thermal conductors is performed by using an electrostatic-painting method.

13. The method of claim 9, wherein the filling of the adhesive material is performed by using a spin coating method.
